(19) United States
(12) Patent Application Publication
(10) Pub. No.: US 2005/0123865 A1
(43) Pub. Date: Jun. 9, 2005

(54) Single-part bleach-fixing composition and method of processing

(75) Inventors: Valerie L. Kuykendall, Penfield, NY (US); Jean M. Buongiorne, Webster, NY (US); Susan M. Flavin, Rochester, NY (US); Eric R. Schmittou, Rochester, NY (US); Paul A. Schwartz, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/874,984

(22) Filed: Jun. 23, 2004

Related U.S. Application Data
(60) Provisional application No. 60/526,485, filed on Dec. 3, 2003.

(51) Int. Cl. G03C 5/40

(52) U.S. Cl. 430/454

(57) ABSTRACT

A method of processing photographic color papers is carried out using an aqueous single-part photographic bleach-fixing composition in a bleach-fixing step for less than 60 seconds. The single-part bleach-fixing composition has a pH of from about from about 4.4 to about 5.4. It comprises at least 0.1 mol/l of an iron ammonium-ligand photographic bleaching agent that comprises at least 95 mol % a ferric ammonium-ligand photographic bleaching agent provided that the ligand in the bleaching agent is not diethylenetriaminepentaacetic acid, at least 0.1 mol/l of a thiosulfate as the sole photographic fixing agent, and sulfite ions present in an amount sufficient to convert at least 50 mol % of the ferric ammonium-ligand photographic bleaching agent to ferrous ammonium-ligand compound within 30 days at 20 to 45° C. At least 90 mol % of the total ammonium and alkali metal cations in the bleach-fixing composition are ammonium ions.

### FIELD OF THE INVENTION

This invention relates in general to photography. More particularly, it relates to a single-part bleach-fixing composition and to a method for its use to rapidly process photographic color papers.

### BACKGROUND OF THE INVENTION

The basic image-forming process of color silver halide photography comprises the exposure of a silver halide color photographic recording material to actinic radiation (such as light) and the manifestation of a useful image by wet chemical processing of the material. A fundamental step of this wet processing is color development to reduce silver halide to silver and to produce dye images in exposed areas of the material.

To obtain useful color images, it is usually necessary to remove all of the silver from the photographic element after color development. This is sometimes known as “desilvering”. Removal of silver is generally accomplished by oxidizing the metallic silver in what is known as a “bleaching” step using a bleaching agent, and then dissolving the oxidized silver and undeveloped silver halide with a silver “solvent” or fixing agent in what is known as a “fixing” step.

It has become common for the processing of certain photographic elements, notably color photographic papers, to combine the bleaching and fixing operations into a single “bleach-fixing” operation that can be carried out in one or more processing steps. Bleach-fixing is usually carried out using a composition that includes both a photographic bleaching agent and a photographic fixing agent, as described in U.S. Pat. No. 4,033,771 (Borton et al.).

The most common bleaching agents for color photographic processing are complexes of ferric [Fe(III)] ion and various organic chelating ligands (such as aminopolycarboxylic acids), of which there are hundreds of possibilities, all with varying photographic bleaching abilities and biodegradability. Common organic chelating ligands used as part of bleaching agents for photographic color film processing include ethylenediaminetetraacetic acid (EDTA), 1,3-propylenediaminetetraacetic acid (PDTA) and nitrilotriacetic acid (NTA). Common color paper bleaching is often carried out using EDTA as a chelating ligand. Also known are bleaching, bleach-fixing compositions, and processing methods that utilize a ferric complex of one or more of several alkyliminodiacetic acids (such as methyliminodiacetic acid or MIDA) that are known to be more biodegradable than other common organic chelating ligands such as EDTA. Other photographic bleaching agents using similar organic chelating ligands are described in U.S. Pat. No. 5,061,608 (Foster et al.).

Typical photographic fixing agents include thiosulfates, sulfites, thiocyanates, and mixtures thereof that readily solubilize or “dissolve” silver ion in the processed photographic materials, as described in U.S. Pat. No. 5,633,124 (Schmittou et al.).

When photographic materials are processed in bleach-fixing steps, the bleach-fixing composition is generally formulated from two or more “parts”, each “part” or solution typically containing one or more (but not all) of the photochemicals necessary for the processing reactions. If all of the chemicals are formulated in a single concentrate solution, storage stability is reduced since unwanted chemical interactions among components are inevitable.

Bleach-fixing compositions are described in U.S. Pat. No. 6,221,570 (Papai), U.S. Pat. No. 6,534,253 (Kuykendall et al.), and U.S. Pat. No. 6,582,893 (Vincent et al.), DE 100 13 614 (Tappe et al.), and EP 1 160 622 (Tappe et al.). Various approaches are taken in the art to provide stability of such compositions. Advances in the art include the use of predominantly “ferrous” bleach-fixing compositions that can be used under a variety of replenishment conditions.

There is a need in the industry for the ability to rapidly process a variety of photographic color papers using single-part bleach-fixing compositions that have desired effectiveness and improved stability (keeping) under a variety of conditions.

### SUMMARY OF THE INVENTION

This invention provides an aqueous single-part photographic bleach-fixing composition that has a pH of from about 4.4 to about 5.4 and comprises:
5 at least 0.1 mol/l of an iron ammonium-ligand photographic bleaching agent that comprises at least 95 mol % a ferric ammonium-ligand photographic bleaching agent, based on total iron, provided that the ligand in the bleaching agent is not diethylenetriaminepentaacetic acid,
at least 0.1 mol/l of a thiosulfate as the sole photographic fixing agent, and
sulfite ions present in an amount sufficient to convert at least 50 mol % of the ferric ammonium-ligand photographic bleaching agent to ferrous ammonium-ligand compound within 30 days at 20 to 45° C.,
wherein at least 90 mol % of the total ammonium and alkali metal cations in the bleach-fixing composition are ammonium ions.

In preferred embodiments of this invention, the aqueous single-part photographic bleach-fixing composition has a pH of from about 4.7 to about 5.3 and comprises:
from about 0.1 to about 0.8 mol/l of an iron ammonium-ligand photographic bleaching agent that comprises at least 98 mol % of ferric ammonium-ethylenediaminetetraacetic acid, ferric ammonium-ethylenediaminedisuccinic acid, or ferric ammonium-1,3-propylenediaminetetraacetic acid, or mixtures thereof, based on total iron, as the photographic bleaching agent(s),
from about 0.1 to about 2 mol/l of a thiosulfate as the sole photographic fixing agent,
from about 0.01 to about 10 mmol/l of 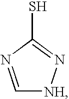
from about 0.01 to about 2 mol/l of sulfite ions that are sufficient to convert at least 75 mol % of the ferric ion to ferrous ion within 30 days at 20 to 45° C.,
wherein at least 95 mol % of the total ammonium and alkali metal cations in the bleach-fixing composition are ammonium ions, and the bleach-fixing composition is substantially free of phosphates, polyphosphates, polyphosphonates, nitrates, and bromide ions.

In addition, this invention provides a method of providing a color photographic image comprising contacting a color developed photographic color paper with the aqueous single-part photographic bleach-fixing composition of the present invention, diluted or undiluted, the contacting being carried out for less than 60 seconds.

Preferred processing methods of this invention for providing a color photographic image comprise:
A) color developing a photographic color paper, and
B) contacting the color developed photographic color paper with an aqueous single-part photographic bleach-fixing composition, diluted or undiluted, that has a pH of from about 4.7 to about 6.5 and comprises:
from about 0.1 to about 0.8 mol/l of an iron ammonium-ligand photographic bleaching agent that comprises at least 98 mol % of ferric ammonium-ethylenediaminetetraacetic acid, ferric ammonium-ethylenediaminedisuccinic acid, or ferric ammonium-1,3-propylenediaminetetraacetic acid, or mixtures thereof, based on total iron, as the photographic bleaching agent(s),
from about 0.1 to about 2 mol/l of a thiosulfate as the sole photographic fixing agent,
from about 0.01 to about 10 mmol/l of 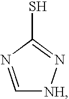
from about 0.01 to about 2 mol/l of sulfite ions that are sufficient to convert at least 75 mol % of the ferric ion to ferrous ion within 30 days at 20 to 45° C.,
wherein at least 95 mol % of the total ammonium and alkali metal cations in said bleach-fixing composition are ammonium ions, and the bleach-fixing composition is substantially free of phosphates, polyphosphates, polyphosphonates, nitrates, and bromide ions,
the contacting being carried out for less than 60 seconds.

Further, the present invention provides a method of providing a stabilized single-part bleach-fixing composition that has a pH of from about 4.4 to about 5.4 and at least 50 mol % ferrous ammonium-ligand compound, based on total iron concentration, the method comprising mixing at least the following components (a), (b), and (c):
(a) at least 0.1 mol/l of an iron ammonium-ligand photographic bleaching agent that comprises at least 95 mol % a ferric ammonium-ligand photographic bleaching agent, based on total iron, provided that the ligand in the bleaching agent is not diethylenetriaminepentaacetic acid,
(b) at least 0.1 mol/l of a thiosulfate as the sole photographic fixing agent, and
(c) sulfite ions in an amount sufficient to convert at least 50 mol % of the ferric ammonium-ligand photographic bleaching agent to ferrous ammonium-ligand compound within 30 days at 20 to 45° C.,
provided that at least 90 mol % of the total ammonium and alkali metal cations mixed into the bleach-fixing composition are ammonium ions, and substantially no phosphates, polyphosphates, polyphosphonates, nitrates, or bromide ions are mixed into the bleach-fixing composition.

This invention also provides a method of converting ferric ions to ferrous ions in a composition comprising:
A) mixing at least the following components (a), (b), and (c):
   (a) at least 0.1 mol/l of an iron ammonium-ligand photographic bleaching agent that comprises at least 95 mol % a ferric ammonium-ligand photographic bleaching agent, based on total iron, provided that the ligand in the bleaching agent is not diethylenetriaminepentaacetic acid,
   (b) at least 0.1 mol/l of a thiosulfate as the sole photographic fixing agent, and
   (c) sulfite ions,
B) holding the mixture of (a), (b), and (c) for up to 30 days at 20 to 45° C. (for example in a capped container such as a capped high density polyethylene bottle),
   provided that at least 90 mol % of the total ammonium and alkali metal cations mixed into the bleach-fixing composition are ammonium ions, and substantially no phosphates, polyphosphates, polyphosphonates, nitrates, or bromide ions are mixed into the bleach-fixing composition, and
   further provided that the sulfite ions are present in an amount sufficient to convert at least 50 mol % of the ferric ammonium-ligand photographic bleaching agent to ferrous ammonium-ligand compound under the conditions of step B.

The method of this invention provides a means for rapid silver removal and rapid photographic processing of a variety of photographic color papers. This processing is carried out using a unique aqueous single-part bleach-fixing composition that is stabilized to various keeping conditions. In addition, this bleach-fixing composition is initially mixed with predominantly (at least 95 mol %) ferric ammonium-ligand bleaching agent but it contains sulfite ions in a sufficient amount to convert at least 50 mol % of the ferric ammonium-ligand photographic bleaching agent to ferrous ammonium-ligand compound within 30 days at 20 to 45° C..

This invention provides a composition whose advantages include ease of use by the customer, improved manufacturability, lower cost, and improved keeping stability (in both high and low temperature environments), and it is less corrosive.

### DETAILED DESCRIPTION OF THE INVENTION

Photographic bleach-fixing is carried out in the practice of this invention using one or more bleach-fixing steps. At least one of those steps is carried out using the aqueous single-part bleach-fixing composition of this invention.

These single-part bleach-fixing compositions include one or more photographic bleaching agents that are Fe(Ill) ammonium-ligand complexes wherein the ligand is a polycarboxylic acid. Preferred polycarboxylic acid ligands include aminopolycarboxylic acid and polyaminopolycarboxylic acid chelating ligands other than diethylenetriaminepentaacetic acid (DTPA).

Particularly useful chelating ligands include such polyaminopolycarboxylic acids as those described in Research Disclosure, publication 38957, pages 592-639 (September 1996), U.S. Pat. No. 5,334,491 (Foster et al.), U.S. Pat. No. 5,582,958 (Buchanan et al.), and U.S. Pat. No. 5,753,423 (Buongiome et al.). Research Disclosure is a publication of Kenneth Mason Publications Ltd., Dudley House, 12 North Street, Emsworth, Hampshire PO10 7DQ England. This reference will be referred to hereinafter as “Research Disclosure.” There are hundreds of possible chelating ligands that are known in the art, the most common useful ones being ethylenediaminetetraacetic acid (EDTA), 1,3-propylenediaminetetraacetic acid (PDTA), cyclohexanediaminetetraacetic acid (CDTA), N-(2-carboxyphenyl)ethylenediamine-N,N′,N″-triacetic acid, and hydroxyethyl-ethylenediaminetriacetic acid (HEDTA). The most preferred ligands include EDTA, EDDS (defined below), and PDTA.

Biodegradable chelating ligands are also useful in order to minimize the impact on the environment from discharged photoprocessing solutions. Particularly useful biodegradable chelating ligands are ethylenediaminedisuccinic acid (EDDS) and other similar compounds that are described in U.S. Pat. No. 5,679,501 (Seki et al.) and EP 0 532 001B1 (Kuse et al.). All isomers of EDDS are useful and the isomers can be used singly or in mixtures. The [S,S] isomer is most preferred of the iron-EDDS complexes. Other useful disuccinic acid chelating ligands are described in U.S. Pat. No. 5,691,120 (Wilson et al.).

Aminomonosuccinic acids (or salts thereof) are chelating ligands having at least one nitrogen atom to which a succinic acid (or salt) group is attached. These chelating ligands are also useful in iron complexes. U.S. Pat. No. 5,652,085 (Stickland et al.) also provides more details about such chelating ligands, particularly the polyamino monosuccinic acids such as ethylenediamine monosuccinic acid (EDMS).

Other classes of biodegradable aminopolycarboxylic acid or polyaminopolycarboxylic acid chelating ligands that can be used to form biodegradable iron complexes include iminodiacetic acid and its derivatives (or salts thereof), including alkyliminodiacetic acids that have a substituted or unsubstituted alkyl group having 1 to 6 carbon atoms (such as methyl, ethyl, n-propyl, hydroxymethyl, isopropyl, and t-butyl) as described in EP 0 532 003A1 (Kuse et al.). Particularly useful alkyliminodiacetic acids are methyliminodiacetic acid (MIDA) and ethyliminodiacetic acid (EIDA).

All chelating ligands useful in this invention can be present in the free acid form or as alkali metal (for example, sodium and potassium) or ammonium salts, or as mixtures thereof, as long as at least 90 mol %, and preferably at least 95 mol %, of the total amount of ammonium and alkali metal ions in the bleach-fixing composition are ammonium ions.

Still other biodegradable chelating ligands can be represented by the following Structure LIGAND: 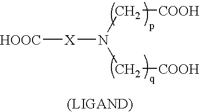
wherein p and q-are independently 1,.2 and 3, and preferably each is 1. The linking group X may be any divalent group that doers not bind ferric ion and does not cause the resulting ligand to be water-insoluble. Preferably, X is a substituted or unsubstituted alkylene group, substituted or unsubstituted arylene group, substituted or unsubstituted arylenealkylene group, or substituted or unsubstituted alkylenearylene group.

The ferric ligand complexes useful in this invention can be binary complexes (meaning iron is complexed to one or more molecules of a single chelating ligand) or ternary complexes in which iron is complexed to molecules of two distinct chelating ligands similar to iron complexes described for example in U.S. Pat. No. 5,670,305 (Gordon et al.) and U.S. Pat. No. 5,582,958 (noted above). A mixture of multiple binary or ternary iron complexes also can be present in the compositions.

Still other useful biodegradable iron chelating ligands include but are not limited to, alaninediacetic acid, P3-alaninediacetic acid (ADA), nitrilotriacetic acid (NTA), glycinesuccinic acid (GSA), 2-pyridylmethyliminodiacetic acid (PMIDA), citric acid, and tartaric acid.

As used herein, the terms “biodegradable” and “biodegradability” refer to at least 80% decomposition in the standard test protocol specified by the Organization for Economic Cooperation and Development (OECD), OECD 301B “Ready Biodegradability: Modified Sturm Test” that is well known in the photographic processing art.

Ferric ions in the photographic bleaching agents can be provided from any conventional source including iron salts and iron oxides such as magnetite. Liquid ferric ammonium EDTA is a preferred source of ferric ions, and is available from a number of commercial sources.

Iron present in the bleach-fixing composition of the present invention is present predominantly (at least 95 mol % and preferably at least 98 mol %) in ferric ion form. However,,as described below, the sulfite ions in the composition gradually reduce the ferric ions to ferrous ions to provide desired composition stability. The ferrous ions can be oxidized at an appropriate time prior to or during use in an appropriate way as described in U.S. Pat. Nos. 6,534,253 and 6,582,893 (both noted above), both incorporated herein by reference.

It is not necessary that the ferric ion and the chelating ligand(s) be present in the photographic bleach-fixing compositions in stoichiometric proportions. It is preferred, however, that the molar ratio of the total chelating ligands to ferric ion be from about 1:1 to about 5:1. In a more preferred embodiment, the ratio is about 1:1 to about 2.5:1 moles of total chelating ligands per mole of ferric ion.

The one or more iron ammonium-ligand photographic bleaching agents are present in an amount of at least 0.1 mol/l and up to 0.8 mol/l, and preferably from about 0.2 to about 0.6 mol/l.

One or more rehalogenating agents may also present in the bleach-fixing compositions. Chloride, iodide ions, or mixtures of these halides are common halogenating agents. Such ions are provided in the form of water-soluble salts including ammonium, alkali metal and alkaline earth metal salts.

The single-part bleach-fixing compositions of this invention can be introduced directly into or mixed in a processing chamber, vessel, or tank as the working strength or used as a replenisher to a working strength processing solution. The compositions can be used immediately after mixing, but more likely it is packaged, shipped, and stored before use by the customer. The bleach-fixing composition of this invention generally has a pH of from about 4.4 to about 5.4 and preferably from about 4.7 to about 5.3. Composition pH, however, may rise under certain conditions up to 6.5. For example, during processing the composition pH may-be from about 4.7 to about 6.5. In defining the pH, the term “about” refers to at most ±0.1 pH unit.

The photographic bleach-fixing compositions of the present invention also include one or more thiosulfate photographic fixing agents. Various thiosulfates include sodium thiosulfate, potassium thiosulfate, ammonium thiosulfate, lithium thiosulfate, calcium thiosulfate, magnesium thiosulfate, or mixtures thereof. Preferably, ammonium thiosulfate is used. The amount of thiosulfate fixing agent(s) is at least 0.1 mol/l and up to 2 mol/l, preferably from about 0.3 to about 1.8 mol/l. The bleach-fixing compositions of this invention comprise substantially no thiocyanates or other known fixing agents (that is, less than 0.01 mol/l).

Sulfite ions are present in the bleach-fixing compositions of this invention are present in an amount sufficient to convert at least 50 mol % of the one or more ferric ammonium-ligand photographic bleaching agents to ferrous ammonium-ligand compound within 30 days at 20 to 45° C. (preferably at least 75 mol % of ferric ion to ferrous ion conversion). Generally, this amount of sulfite ions is at least 0.1 mol/l and up to 4 mol/l, and preferably from about 0.2 to about 2 mol/l. However, the particular amount useful in a given composition can be determined by a skilled artisan by determining how much sulfite ion is required to convert (or reduce) a given amount of ferric ions to ferrous ions at a given temperature and within a given time period. By this means, ferric ions in a bleaching agent can be readily converted (or reduced) to ferrous ions.

The sulfite ions can be introduced in various salts including but not limited to, ammonium sulfite, ammonium bisulfite, ammonium metabisulfite, sodium metabisulfite, sodium sulfite, potassium sulfite, and potassium metabisulfite. Preferably, sulfite ions are provided as ammonium bisulfite.

An optional but preferred component of the bleach-fixing composition of the present invention is a sulfur-containing compound represented by any of the following Structures I, II, III, IVa, IVb, and V, or mixtures thereof.

Useful sulfur-containing compounds can be represented by Structure I: 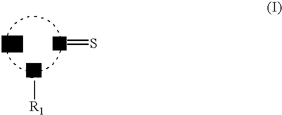
wherein Q₁ represents a group of atoms that are necessary to complete a substituted or unsubstituted nitrogen-containing heterocyclic ring including a ring condensed with a 5- or 6-membered unsaturated ring. In particular, Q₁ provides the atoms necessary to provide a pyrrole, pyrrolidine, pyrazole, pyrazolidine, imidazole, imidazoline, imidizolidine, triazole, triazoline, triazolidine, thiazole, thiazoline, thiazolidine, thiadiazole, thiadiazoline, thiadiazolidine, oxazole, oxazoline, oxazolidine, oxadiazole, oxadiazoline, oxadiazolidine, pyridine, piperidine, pyrazine, piperazine, pyrimidine, morpholine, azine, oxazine, dioxazine, thiazine, dithiazine, oxathiazine, diazine, oxadiazine, thiadiazine, or triazine heterocyclic ring. RI represents hydrogen, a substituted or unsubstituted alkyl group, a substituted or unsubstituted cycloalkyl group, a substituted or unsubstituted aryl group, a substituted or unsubstituted heterocyclic group including those each condensed with a 5- or 6-membered unsaturated ring, or an amino group. All of these groups are defined in more detail below.

Other useful sulfur-containing compounds are represented by Structure II: 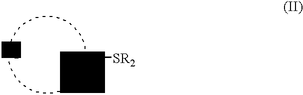
wherein Q₂ represents a group of atoms that are necessary to complete a substituted or unsubstituted nitrogen-containing heterocyclic ring including those each condensed with at 5- or 6-membered unsaturated ring. In particular, Q₂ provides the atoms necessary to provide a pyrrole, pyrrolidine, pyrazole, pyrazolidine, imidazole, imidazoline,.imidizolidine, triazole, triazoline, triazolidine, thiazole, thiazoline, thiazolidine, thiadiazole, thiadiazoline, thiadiazolidine, oxazole, oxazoline, oxazolidine, oxadiazole, oxadiazoline, oxadiazolidine, pyridine, piperidine, pyrazine, piperazine, pyrimidine, morpholine, azine, oxazine, dioxazine, thiazine, dithiazine, oxathiazine, diazine, oxadiazine, thiadiazine, or triazine heterocyclic ring. R₂ represents a hydrogen atom, an alkali metal atom, a 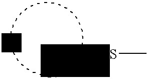
group wherein Q₃ is defined the same as Q₂, or a substituted or unsubstituted alkyl group.

Still other useful sulfur-containing compounds are represented by Structure III: 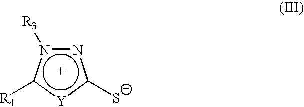
wherein R₃ and R₄ are independently substituted or unsubstituted alkyl groups, substituted or unsubstituted cycloalkyl groups, substituted or unsubstituted alkenyl groups, substituted or unsubstituted alkynyl groups, substituted or unsubstituted aralkyl groups, substituted or unsubstituted aryl groups, or substituted or unsubstituted heterocyclic groups, or R₄ can be hydrogen. Y is —O—, —S—, or —N(R5)- wherein R₅ is hydrogen, or a substituted or unsubstituted alkyl, substituted or unsubstituted cycloalkyl, substituted or unsubstituted alkenyl, substituted or unsubstituted alkynyl, substituted or unsubstituted-aryl, substituted or unsubstituted heterocyclic, amino, substituted or unsubstituted acylamino, sulfonamido, substituted or unsubstituted ureido, or sulfamoylamino group. Alternatively, R₃ and R₄, or R₄ and R₅, taken together, may form a substituted or unsubstituted heterocyclic ring. Preferably, Y is —N(R₅)— and R₅ is hydrogen, or a substituted or unsubstituted alkyl, substituted or unsubstituted alkenyl, substituted or unsubstituted alkynyl, or substituted or unsubstituted heterocyclic group.

Still additional useful sulfur-containing compounds are represented by the following Structures IVa and IVb: 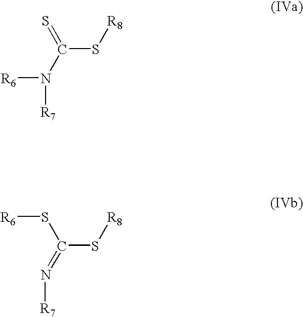
wherein Structures IVa and IVb represent tautomeric forms of the carbamodithioic acid or carbamodithioic ester functional group that may particularly coexist when R₆ is hydrogen or an alkali metal ion. Groups R₆, R₇, and R₈ independently represent hydrogen, alkali metal ions, or substituted or unsubstituted alkyl, substituted or unsubstituted cycloalkyl, substituted or unsubstituted alkenyl, substituted or unsubstituted alkynyl, substituted or unsubstituted aralkyl, substituted or unsubstituted aryl, substituted or unsubstituted heterocyclic, substituted or unsubstituted amino, acylamino, ureido, or sulfamoylamino groups.

In addition, the sulfur-containing compounds useful in this invention can be represented by Structure V: 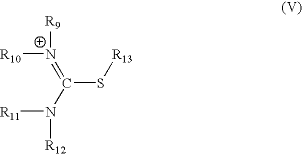
based on the functional group commonly known as an isothiuronium salt, but may also include deprotonated forms of the —S—C(═N)N— group. Groups R₉, R₁₀, R₁₁ and R₁₂ independently represent hydrogen, alkali metal ions, or substituted or unsubstituted alkyl, substituted or unsubstituted cycloalkyl, substituted or unsubstituted alkenyl, substituted or unsubstituted alkynyl, substituted or unsubstituted aralkyl, substituted or unsubstituted aryl, substituted or unsubstituted heterocyclic, substituted or unsubstituted amino, acylamino, ureido, or sulfamoylamino groups. Group R₁₃ represents a substituted or unsubstituted alkyl, substituted or unsubstituted cycloalkyl, substituted or unsubstituted alkenyl, substituted or unsubstituted alkynyl, substituted or unsubstituted aralkyl, substituted or unsubstituted aryl, substituted or unsubstituted heterocyclic, substituted or unsubstituted amino, acylamino, ureido, or sulfamoylamino group.

For the substituents in the noted Structures I, II, III, IVa, IVb, and V, the substituted or unsubstituted alkyl group substituents can have from 1 to 6 carbon atoms. Representative alkyl groups include, but are not limited to, methyl, ethyl, n-propyl, t-butyl, methoxyethyl, methylthioethyl, dimethylaminoethyl, morpholinoethyl, dimethylaminoethylthioethyl, diethylaminoethyl, aminoethyl, methylthiomethyl, trimethylammonioethyl, carboxymethyl, carboxyethyl, carboxypropyl, sulfoethyl, sulfomethyl, phosphonomethyl, and phosphonoethyl groups. Preferred substituted or unsubstituted alkyl groups have 1 to 3 carbon atoms and can be substituted with amino or hydroxy groups.

The substituted or unsubstituted cycloalkyl substituents can have from 5 to 10 carbon atoms in the cyclic ring and include, for example, as cyclohexyl, cyclopentyl, and 2-methylcyclohexyl groups. Substituted or unsubstituted cyclohexyl groups are preferred.

The substituted or unsubstituted carbocyclic aryl groups can have from 6 to 10 carbon atoms in the aromatic ring and include, for example, phenyl, naphthyl, 4-methylphenyl, 4-methoxyphenyl, 4-carboxyphenyl, and 4-sulfophenyl groups. Substituted or unsubstituted phenyl groups are preferred.

The substituted or unsubstituted heterocyclic substituent groups in the noted Structures can have from 5 to 10 atoms including one or more of any of nitrogen, oxygen, and sulfur atoms, and the remaining atoms being carbon atoms. Such groups include, but are note limited to, 2-pyridyl, 3-pyridyl, 4-pyridyl, 2-thienyl, 1-pyrazolyl, 1-imidazolyl, and 2-tetrahydrofiryl groups. Preferred substituted and unsubstituted heterocyclic groups include the pyridyl groups.

The amino groups described above can be primary, secondary or tertiary amines having appropriate alkyl, aryl, or cycloalkyl groups attached to the amine nitrogen atom, and include for example primary amino, dimethylamino, and methylamino groups. Primary amino groups, and secondary and tertiary amino groups having alkyl group substituents with 1 to 3 carbon atoms are preferred.

Alkali metal ions useful in the sulfur-containing compounds of Structure II include lithium, sodium, potassium, and cesium metal ions.

Substituted or unsubstituted alkenyl groups have 2 to 10 carbon atoms and include, for example, as allyl and 2-methylallyl groups. Substituted or unsubstituted alkynyl groups have 2 to 10 carbon atoms and include, for example, propargyl groups.

Substituted or unsubstituted aralkyl groups are really aryl-substituted alkyl groups having 7 to 14 carbon atoms in the unsubstituted alkyl-aryl portion of the group. Representative aralkyl groups include, but are not limited to, benzyl, phenethyl and 4-methoxybenzyl groups. The substituted or unsubstituted benzyl groups are preferred.

Representative substituted or unsubstituted acylamino groups are acetylamino, benzoylamino, and methoxypropionylamino groups. Representative substituted or unsubstituted ureido groups include unsubstituted ureido and 3-methylureido groups, and representative substituted or unsubstituted sulfamoylamino groups include unsubstituted sulfamoylamino and 3-methylsulfamoylamino groups.

It is also preferable that the sulfur-containing compound (cyclic or acyclic) compounds of Structure I, II, III, IVa, IVb, and V have a net neutral or positive charge in an aqueous solution at pH 6.2. This usually means that compounds having anionic groups are less desirable.

As noted above, the sulfur-containing compounds can be acyclic or cyclic in structure but the preferred compounds are 5- or 6-membered heterocyclic compounds comprising at least one nitrogen atom in the ring. More preferably, such cyclic compounds comprise a —N═C(SH)— or —N—C(S═)— moiety as part of the ring. The heterocyclic rings can also include additional nitrogen atoms as well as carbon, oxygen, or sulfur atoms.

These heterocyclic compounds may have no substituents other than the mercapto moiety, but in some embodiments, the 5- or 6-membered ring is further substituted with one or more substituents as described above for Structures I, II, III, IVa, IVb, and V and especially alkyl groups.

Representative sulfur-containing compounds are the following sulfur-containing compounds (I) through (XIV):

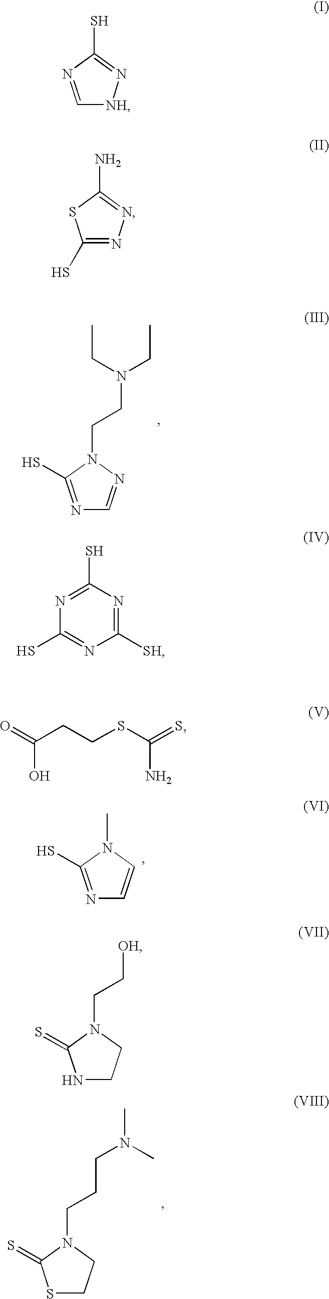

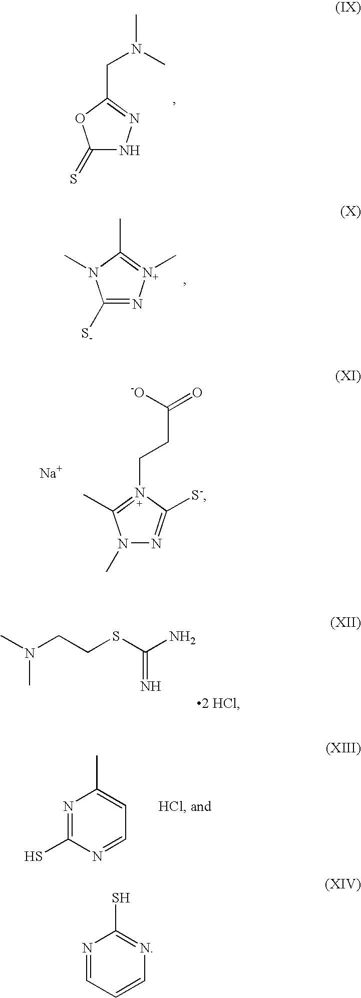

Mixtures of two or more of the sulfur-containing compounds can be present in the bleach-fixing compositions (and replenishers). Sulfur-containing compounds (I), (II), and (III) are preferred.

The compounds described above as having a mercapto moiety are generally present in the bleach-fixing composition in an amount of at least 0.01 mmol/l and preferably in an amount of at least 0.04 mmol/l. The upper limit is generally 100 mmol/l and a preferred upper limit is 10 mmol/l.

The noted sulfur-containing compounds can be obtained in a number of ways. Some of them can be purchased from commercial sources such as Aldrich Chemical Company and Lancaster Synthesis Limited. Others can be prepared using common starting materials and synthetic procedures that would be apparent to one skilled in the art.

Water can be mixed with the bleach-fixing composition of this invention at a volume ratio (relative to the composition) of from about 1:10 to about 10:1 (composition:water), and preferably at a volume ratio of from about 1:2 to about 2:1 (composition:water). Thus, the composition of this invention can be used in diluted or undiluted form.

Optional addenda that can be present in the photographic bleach-fixing composition if desired are materials that do not adversely affect its photographic bleaching and fixing functions. Such materials include, but are not limited to, biocides, photographic hardeners, metal ion sequestering agents (such as polycarboxylic acids and polyaminopolycarboxylic acids), buffers including organic acid buffering agents in an amount of at least 0.2 mol/l (such as carboxylic acids including but not limited to, acetic acid, succinic acid, glycolic acid, propionic acid, malic acid, benzoic acid, sodium bisulfite, ammonium bisulfite, imidazoles, maleic acid and EDTA), bleaching accelerators, fixing accelerators, preservatives, and other materials readily apparent to one skilled in the photographic art. These optional materials can be present in conventional amounts.

The bleach-fixing compositions of this invention are substantially free of phosphates, polyphosphates, polyphosphonates, nitrates, and bromide ions (this means that none of these compounds is present, individually, at a concentration greater than 0.001 mol/l).

The components of the single-part bleach-fixing composition of this invention can be mixed in any desirable order. Generally, they are mixed in the following order: water, acetic acid (or similar acidic buffer), ammonium hydroxide (or similar base), sulfur-containing compound of Structure I, II, III, IV, or V, source of sulfite ions (such as ammonium bisulfite), ferric ammonium-ligand photographic bleaching agent (such as ferric anmnonium-EDTA), and thiosulfate fixing agent (such as ammonium thiosulfate).

During photographic processing, conventional procedures can be used for replenishment of the various processing solutions, including the bleach-fixing composition of this invention. Preferably, the rate of bleach-fixing composition replenishment is not more than 215 ml/m² of processed photographic color paper. The processing equipment can be any suitable processor having one or more processing tanks or chambers, including minilab processors and larger scale processors. The bleach-fixing step can be carried out in one or more chambers, tanks or stages arranged in concurrent or countercurrent flow.

The present invention can be used advantageously with any of the known methods of contacting photographic bleach-fixing compositions and photographic color papers. These methods include, but are not limited to, immersing a color paper in the aqueous bleach-fixing composition (with or without agitation or circulation), bringing the color paper into contact with a web or drum surface that is wet with the bleach-fixing composition, laminating the color paper with a cover sheet or web in such a way that the bleach-fixing composition is brought into contact with the color paper, or applying the bleach-fixing composition to the color paper by high velocity jet or spray.

Bleach-fixing can be generally carried out at a temperature of from about 20 to about 65° C. (preferably from about 30 to about 60° C.). The time of bleach-fixing is generally up to 60 seconds and preferably at least 10 and up to 50 seconds (more preferably from about 18 to about 45 seconds).

The other processing steps desired to provide color images can be similarly rapid or conventional in time and conditions. Preferably the other processing steps, such as color development and/or stabilizing (or rinsing), can be within a wide range of times. For example, color development before bleach-fixing can be carried out for from about 12 to about 360 seconds (preferably less than 50 seconds), and stabilizing (or rinsing) after bleach-fixing can be carried out for from about 15 to about 240 seconds in various processing protocols. The bleach-fixing step can be carried out more than once in some processing methods. The processing methods can have any of a wide number of arrangements of steps, as described for example in U.S. Pat. No. 5,633,124 (noted above) that is incorporated herein by reference.

In rapid processing methods, the total processing time (all wet processing steps) for photographic color papers can be up to 180 seconds (preferably from about 25 to about 120 seconds).

The present invention-can therefore be used to process silver halide color papers (or “positive” image forming materials) of various types for example using Process RA-4 processing conditions and protocols. The various processing sequences, conditions, and solutions for these processing methods-are well known in the art, as well as obvious modifications thereof.

In some embodiments of this invention, an acidic stop solution can be used between color development and the bleach-fixing step. The “stop” solution generally is an aqueous solution having a pH below 7. Preferably, however, bleach-fixing is carried out immediately after color development, that is, without intervening processing steps. One or more stabilizing or rinsing steps can be used before or after bleach-fixing.

Thus, one preferred processing method of the present invention for obtaining color images in photographic color papers includes the following individual processing steps, in order: color development, bleach-fixing, and rinsing and/or stabilizing.

Reagents for color development compositions are well known, and described, for example, in Research Disclosure (noted above), sections XIII and XIX, and the many references described therein. Thus, besides a color developing agent (such as a p-aminophenol or p-phenylenediamine), the color developers can include one or more buffers, antioxidants (or preservatives, such as sulfo-, carboxy, and hydroxy-substituted mono- and dialkylhydroxylamines), antifoggants, fragrances, solubilizing agents, brighteners, halides, sequestering agents, and other conventional addenda. Representative teaching about color developing compositions can also be found in U.S. Pat. No. 4,170,478 (Case et al.), U.S. Pat. No. 4,264,716 (Vincent et al.), U.S. Pat. No. 4,482,626 (Twist et al.), U.S. Pat. No. 4,892,804 (Vincent et al.), U.S. Pat. No. 5,491,050 (Brust et al.), U.S. Pat. No. 5,709,982 (Marrese et al.), U.S. Pat. No. 6,037,111 (Haye et al.), U.S. Pat. No. 6,017,687 (Darmon et al.), and U.S. Pat. No. 6,077,651 (Darmon et al.), and U.S. Ser. No. 09/706,474 (filed Nov. 3, 2000 by Arcus et al.), all incorporated herein by reference.

A preferred photographic color developing composition has a pH of from about 9.5 to about 13 and comprises 4-(N-ethyl-N-2-methanesulfonyl-aminoethyl)-2-methylphenylenediamine sesquisulfate (KODAK Color Developing Agent CD-3), one or more hydroxylamine derivatives as antioxidants, and various addenda commonly included in such compositions.

Stabilizing or rinsing compositions can include one or more surfactants, and in the case of stabilizing compositions, a dye stabilizing compound such as a formaldehyde precursor, hexamethylenetetraamine or various other aldehydes such as m-hydroxybenzaldehyde. Useful stabilizing or rinsing compositions are described in U.S. Pat. No. 4,859,574 (Gonnel), U.S. Pat. No. 4,923,782 (Schwartz), U.S. Pat. No. 4,927,746 (Schwartz), U.S. Pat. No. 5,278,033 (Hagiwara et al.), U.S. Pat. No. 5,441,852 (Hagiwara et al.), U.S. Pat. No. 5,529,890 (McGuckin et al.), U.S. Pat. No. 5,534,396 (McGuckin et al.), U.S. Pat. No. 5,578,432 (McGuckin et al.), U.S. Pat. No. 5,645,980 (McGuckin et al.), and U.S. Pat. No. 5,716,765 (McGuckin et al.), all incorporated herein by reference.

The emulsions and other components, and structure of photographic-color papers and other color “positive” materials processed using this invention and the various procedures for manufacturing them are well known and described in considerable publications, including, for example, Research Disclosure, publication 38957, pages 592-639 (September 1996), and Research Disclosure, Volume 370, February 1995, and hundreds of references noted therein. More details about such materials are provided herein below. In particular, the invention can be practiced with photographic color papers containing any of many varied types of silver halide crystal morphology, sensitizers, color couplers, and addenda known in the art, as described in the noted Research Disclosure publication and the many publications noted therein. The color papers can have one or more layers, at least one of which is a silver halide emulsion layer that is sensitive to electromagnetic radiation, disposed on a suitable resin-coated paper support. The supports can be subbed or unsubbed and coated with various antihalation, antistatic, or other non-imaging layers as is known in the art. Generally, the color papers are multi-color materials having three different color records comprising the appropriate color forming chemistry.

For example, the present invention can be used to provide color images in photographic color papers including, but not limited to, the following commercial products: KODAK® SUPRA ENDURA Color Papers (Eastman Kodak Company), KODAK® PORTRA ENDURA Color Papers (Eastman Kodak Company), KODAK® ULTRA ENDURA Color Papers (Eastman Kodak Company), KODAK® EKTACOLOR®0 Generations Color Papers (Eastman Kodak Company), KODAK® ROYAL® Generations Color Papers (Eastman Kodak Company), KODAK® Perfect Touch Color Paper, KODAK® PORTRA Black and White Color Paper, KODAK® ULTRA III Color Papers (Eastman Kodak Company), Fujicolor Super Color Papers (Fuji Photo Co., FA5, FA7, FA9, Type D and Type DII), Fujicolor Crystal Archive Color Papers (Fuji Photo Co., Digital Paper Type DP, Professional Paper Type DP, Professional Type CD, Professional Type CDII, Professional Type PD, Professional Type PDII, Professional Type PIII, Professional Type SP, Type One, Professional Paper Type MP, Type D and Type C), Fuji Prolaser (Fuji Photo Co.), KONICA COLOR QA Color Papers (Konica, Type QA6E and QA7, Type AD Amateur Digital, Type CD Professional Digital), Konica Color Paper Professional SP (Konica), Konica Color Paper Professional HC (Konica), Konica Color Paper Professional for Digital Type CD (Konica), Agfa Prestige Color Papers (AGFA, Digital and Prestige II), Agfa Laser II Paper (AGFA), Agfa Professional Portrait (AGFA), Agfa Professional Signum II (AGFA), Mitsubishi Color Paper SA Color Papers (Mitsubishi, Type SA-C, Type SA-PRO-L and Type SA-PRO-H).

KODAK® DURATRANS®, KODAK® DURACLEAR, KODAK® EKTAMAX RA and KODAK® DURAFLEX transparent photographic color positive materials and KODAK® Digital Paper Type 2976 can also be processed using the present invention.

The following examples are provided to illustrate the practice of the present invention and are not meant to be limiting in any way.

### EXAMPLE 1

### Single-Part Bleach-Fixing Composition

A single-part bleach-fixing composition of this invention, having a pH of 5.3 was formulated by mixing the following components:

| | | |
|---|---|---|
| Acetic acid, glacial | 30 | g |
| Ammonium bisulfite (45 wt. %) | 166 | g (0.75 mol/l sulfite ions) |
| 1,2,4-triazole-3-thiol | 0.112 | g (0.0011 mol/l) |
| Ferric ammonium EDTA (44 wt. %) | 265 | g (0.32 mol/l) |
| Ammonium thiosulfate (56.5 wt %) | 320 | g (1.22 mol/l) |
| Ammonium hydroxide (57 wt. %) | 4.09 | g |
| Water to make 1 liter | | |

### EXAMPLE 2

### Photographic Color Paper Processing

After imagewise exposure, samples of KODAK® SUPRA ENDURA Color Paper, KODAK® PORTRA ENDURA Color Paper, KODAK® ULTRA ENDURA Color Paper, KODAK® EKTACOLOR® Generations Color Paper, KODAK® PORTRA Black and White Color Paper, FUJICOLOR Crystal Archive Color Papers (Professional Type PDII) were processed using the conditions noted below in TABLE I using the color developer and stabilizer/rinse compositions described below and the bleach-fixing composition of Example 1. Acceptable color images were obtained.

TABLE I

| | Processing | | |
|---|---|---|---|
| Processing | Time | Processing | Replenishment |
| Solution | (seconds) | Temperature (° C.) | Rate (ml/m²) |
| Color developing | 45 | 38 | 80 |
| Bleach-fixing | 45 | 38 | 54 |
| Stabilizing/rising | 90 | 37 | 200 |

Color developing was carried out using a concentrated single-part color developer as described in U.S. Pat. No. 6,077,651 (Darmon et al.), incorporated by reference. Stabilizing/rinsing was carried out using the following concentrated solution:

Stabilizer/Rinse:

| | | |
|---|---|---|
| Water | 908.7 | g/l |
| Glacial acetic acid | 1.98 | g/l |
| Sodium hydroxide (50% solution) | 1.2 | g/l |
| Copper nitrate (41% solution) | 1.39 | g/l |
| Poly(vinyl pyrrolidone) K-15 | 29.68 | g/l |
| Kathon ™ LX biocide solution | 51.23 | g/l |
| Empicol ESC3A2 anionic | 24.45 | g/l |
| sulfate surfactant | | |

### EXAMPLE 3

### Iron Reduction in Sinile-part Bleach-Fixing Composition

A single-part bleach-fixing composition of this invention, having a pH of 5.3 was formulated as described in Example 1. The composition was placed in capped high-density polyethylene bottles. The concentration of iron present as ferrous ion and the sulfite concentration were measured over time at three keeping temperatures to monitor the reduction of ferric ammonium EDTA with sulfite to produce ferrous ammonium EDTA. As can be seen in the following TABLE II, the concentration of sulfite in the solution decreased with time at all three keeping temperatures. The higher the keeping temperature, the more readily the concentration decreased.

TABLE II

| Time | Sulfite Ion Concentration (g/l) | | |
|---|---|---|---|
| (months) | 21° C. | 32° C. | 43° C. |
| 0 | 91.5 | 91.5 | 91.5 |
| 0.5 | 86.8 | 78.7 | 74.6 |
| 1 | 78.6 | 74.6 | 66.4 |
| 2 | 75.2 | 71.9 | 65.9 |
| 3 | 69.9 | 68.5 | 61.7 |
| 4 | 69.6 | 59.0 | 59.3 |

Simultaneously with the decrease in sulfite concentration, an increase in ferrous concentration occurred at all three keeping temperatures as the sulfite ions converted (or reduced) the ferric ammonium EDTA to ferrous ammonium EDTA. This is shown in the following Table III.

TABLE III

| Time | Ferrous Ion Concentration (% iron) | | |
|---|---|---|---|
| (months) | 21° C. | 32° C. | 43° C. |
| 0 | 22 | 22 | 22 |
| 0.5 | 38 | 69 | 88 |
| 1 | 57 | 78 | 91 |
| 2 | 67 | 89 | 94 |
| 3 | 71 | 91 | 95 |
| 4 | 74 | 87 | 91 |

As shown in these data, upon passage of one month (30 days) at three keeping temperatures, at least 50% of the ferric ammonium EDTA had been converted (reduced) to ferrous ammonium EDTA. This conversion results in stability of the thiosulfate fixing agent, as can be seen in the following Table IV.

TABLE IV

| Time | Thiosulfate Concentration (ml 57%/l) | | |
|---|---|---|---|
| (months) | 21° C. | 32° C. | 43° C. |
| 0 | 240 | 240 | 240 |
| 0.5 | 258 | 259 | 260 |
| 1 | 244 | 246 | 248 |
| 2 | 242 | 248 | 241 |
| 3 | 237 | 249 | 249 |
| 4 | 247 | 249 | 252 |

No sulfur formation was observed in these compositions over the time period studied at any of the keeping temperatures. With the ferric ammonium EDTA converted to ferrous ammonium EDTA, the thiosulfate in the solution is protected from decomposition via reaction with ferric ion. In addition, the quantity of sulfite ion remaining in the solution after reaction with ferric ammonium EDTA was sufficient to stabilize the thiosulfate as well.

### COMPARATIVE EXAMPLE 1

A bleach-fixing composition outside of this invention was prepared having the components noted in TABLE V below. Sulfur formation occurred in this composition when treated similarly to the bleach-fixing composition of this invention described in Example 3, and in particular, when kept at 43° C. for 4.5 months after the sulfite concentration had dropped to near zero.

TABLE V

| Component | Amount | |
|---|---|---|
| Sodium metabisulfite | 0.20 | mol/l sulfite ions |
| Acetic acid (90%) | 16.5 | g/l |
| Ferric ammonium EDTA (44%) | 0.16 | mol/l |
| Free EDTA | 4.9 | g/l |
| Ammonium thiosulfate (59%) | 0.67 | mol/l thiosulfate |
| Ammonium bisulfite (45%) | 0.039 | mol/l sulfite ions |

The invention has been described in detail with particular reference to certain preferred embodiments thereof, but it will be understood that variations and modifications can be effected within the spirit and scope of the invention.

1. An aqueous single-part photographic bleach-fixing composition that has a pH of from about 4.4 to about 5.4 and comprises:
at least 0.1 mol/l of an iron ammonium-ligand photographic bleaching agent that comprises at least 95 mol % a ferric ammonium-ligand photographic bleaching agent, based on total iron, provided that the ligand in said bleaching agent is not diethylenetriaminepentaacetic acid,
at least 0.1 mol/l of a thiosulfate as the sole photographic fixing agent, and
sulfite ions present in an amount sufficient to convert at least 50 mol % of said ferric ammonium-ligand photographic bleaching agent to ferrous ammonium-ligand compound within 30 days at 20 to 45° C.,
wherein at least 90 mol % of the total ammonium and alkali metal cations in said bleach-fixing composition are ammonium ions.

2. The composition of claim 1 that is substantially free of phosphates, polyphosphates, polyphosphonates, nitrates, and bromide ions.

3. The composition of claim 1 further comprising at least 0.2 mol/l of an organic acid buffering agent.

4. The composition of claim 3 wherein said organic acid buffering agent is a carboxylic acid buffering agent.

5. The composition of claim 1 further comprising at least 0.01 mmol/l of a sulfur-containing compound represented by one or more of the following Structures I, II, III, IVa, IVb, and V: 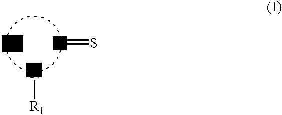
wherein Q₁ represents a group of atoms that are necessary to complete a nitrogen-containing heterocyclic ring, and R₁ represents hydrogen, or an alkyl, cycloalkyl, aryl, heterocyclic, or amino group, 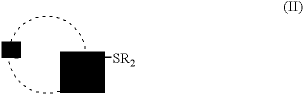
wherein Q₂ represents a group of atoms that are necessary to complete a nitrogen-containing heterocyclic ring, and R₂ represents hydrogen, an alkali metal atom, a 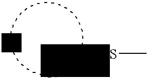
group wherein Q₃ is defined the same as Q₂, or an alkyl group, 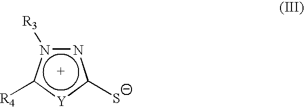
wherein R₃ and R₄ are independently alkyl, cycloalkyl, alkenyl, alkynyl, aralkyl, aryl, or heterocyclic groups, or R₄ can be hydrogen, and Y is —O—, —S—, or —N(R₅)— wherein R₅ is an alkyl, cycloalkyl, alkenyl, alkynyl, aryl, heterocyclic, amino, acylamino, sulfonamido, ureido, or sulfamoylamino group, or R₃ and R₄, or R₄ and R₅, taken together, independently, may form a heterocyclic ring, 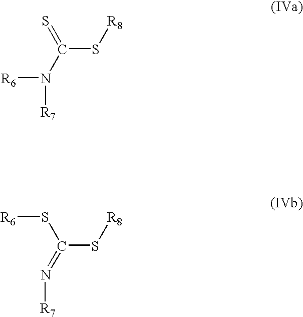
wherein R_{6,} R₇, and R₈ independently represent hydrogen, alkali metal ions, or alkyl, cycloalkyl, alkenyl, alkynyl, aralkyl, aryl, heterocyclic, amino, acylamino, ureido, or sulfamoylamino groups, and 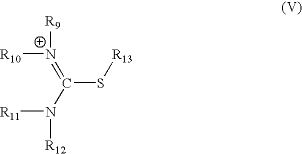
wherein R₉, R₁₀, R₁₁ and R₁₂ independently represent hydrogen, alkali metal ions, or alkyl, cycloalkyl, alkenyl, alkynyl, aralkyl, aryl, heterocyclic, amino, acylamino, ureido, or sulfamoylamino groups, and R₁₃ represents an alkyl, cycloalkyl, alkenyl, alkynyl, aralkyl, aryl, heterocyclic, amino, acylamino, ureido, or sulfamoylamino group.

6. The composition of claim 5 wherein said sulfur-containing compound is a 5- to 6-membered N-heterocyclic compound having no other substituents besides the mercapto moiety.

7. The composition of claim 5 wherein said sulfur-containing compound is one or more of the following compounds (I) through (XIV):

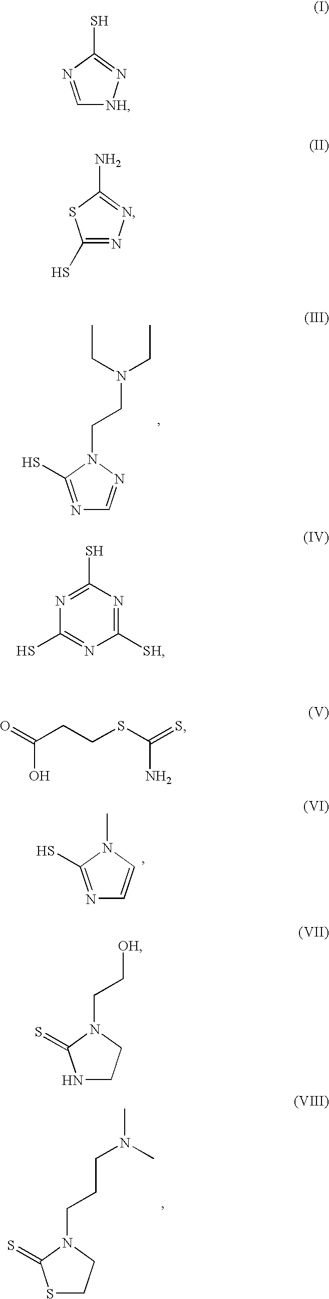

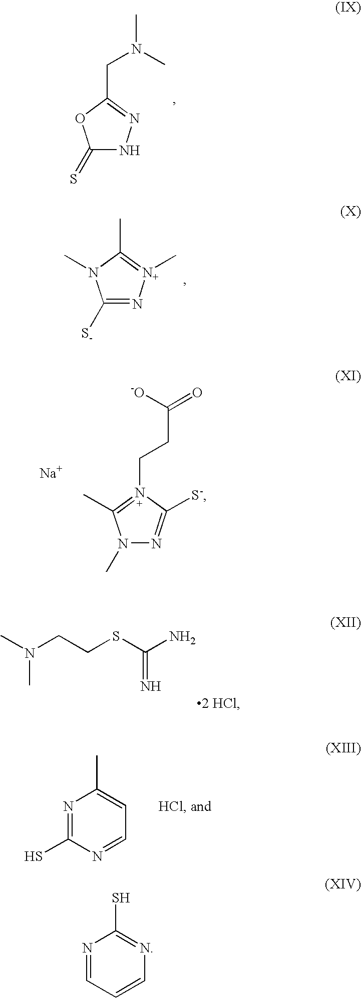

8. The composition of claim 5 wherein said sulfur-containing compound is present in said photographic bleach-fixing composition in an amount of from about 0.01 to about 100 mmol/l.

9. The composition of claim 1 having a pH of from about 4.7 to about 5.3.

10. The composition of claim 1 wherein said ferric-ligand photographic bleaching agent is present in an amount of from about 0.1 to about 0.8 mol/l, said thiosulfate is present in said photographic bleach-fixing composition in an amount of from about 0.1 to about 2 mol/l, and said sulfite ions are present in an amount of from about 0.01 to about 2 mol/l.

11. The composition of claim 1 wherein said ferric-ligand photographic bleaching agent is a ferric ion complex of an aminopolycarboxylic acid or a polyaminopolycarboxylic acid.

12. The composition of claim 11 wherein said ferric-ligand photographic bleaching agent is a ferric ion complex of ethylenediaminetetraacetic acid, ethylenediaminedisuccinic acid, methyliminodiacetic acid, ethyliminodiacetic acid, ethylenediaminemonosuccinic acid, nitrilotriacetic acid, glycinesuccinic acid, 2-pyridylmethyliminodiacetic acid, β-alaninediacetic acid, 1,3-propylenediaminetetraacetic acid, or mixtures of two or more of these.

13. The composition of claim 1 wherein at least 95 mol % of the total ammonium and alkali metal cations in said bleach-fixing composition are ammonium ions.

14. An aqueous single-part photographic bleach-fixing composition that has a pH of from about 4.7 to about 5.3 and comprises:
from about 0.1 to about 0.8 mol/l of an iron ammonium-ligand photographic bleaching agent that comprises at least 98 mol % of ferric ammonium-ethylenediaminetetraacetic acid, ferric ammonium-ethylenediaminedisuccinic acid, or ferric ammonium-1,3-propylenediaminetetraacetic acid, based on total iron, or mixtures thereof, as the photographic bleaching agent(s),
from about 0.1 to about 2 mol/l of a thiosulfate as the sole photographic fixing agent,
from about 0.01 to about 10 mmol/l of 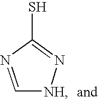
from about 0.01 to about 2 mol/l of sulfite ions that are sufficient to convert at least 75 mol % of said ferric ion to ferrous ion within 30 days at 20 to 45° C.,
wherein at least 95 mol % of the total ammonium and alkali metal cations in said bleach-fixing composition are ammonium ions, and said bleach-fixing composition is substantially free of phosphates, polyphosphates, polyphosphonates, nitrates, and bromide ions.

15. A method of providing a color photographic image comprising contacting a color developed photographic color paper with an aqueous single-part photographic bleach-fixing composition, diluted or undiluted, that has a pH of from about 4.4 to about 6.5 and comprises:
at least 0.1 mol/l of an iron ammonium-ligand photographic bleaching agent that comprises at least 95 mol % a ferric ammonium-ligand photographic bleaching agent, based on total iron, provided that the ligand in said bleaching agent is not diethylenetriaminepentaacetic acid,
at least 0.1 mol/l of a thiosulfate as the sole photographic fixing agent, and
sulfite ions present in an amount sufficient to convert at least 50 mol % of said ferric ammonium-ligand photographic bleaching agent to ferrous ammonium-ligand compound within 30 days at 20 to 45° C.,
wherein at least 90 mol % of the total ammonium and alkali metal cations in said bleach-fixing composition are ammonium ions,
said contacting being carried out for less than 60 seconds.

16. The method of claim 15 wherein said bleach-fixing composition is diluted with water during or upon delivery to said processing chamber at a volume ratio relative to said composition of from about 1:10 to about 10:1 (composition:water).

17. The method of claim 15 wherein said bleach-fixing contacting follows color development immediately without any intervening steps, and said bleach-fixing contacting is followed by one or more stabilizing or rinsing steps.

18. The method of claim 15 wherein said bleach-fixing contacting follows color development and contacting of said color developed photographic color paper with an acidic stop solution.

19. A method of providing a color photographic image comprising:
(A) color developing a photographic color paper, and
(B) contacting said color developed photographic color paper with an aqueous single-part photographic bleach-fixing composition, diluted or undiluted, that has a pH of from about 4.7 to about 5.8 and comprises:
from about 0.1 to about 0.8 mol/l of an iron ammonium-ligand photographic bleaching agent that comprises at least 98 mol % of ferric ammonium-ethylenediaminetetraacetic acid, ferric ammonium-ethylenediaminedisuccinic acid, or ferric ammonium-1,3-propylenediaminetetraacetic acid, based on total iron, or mixtures thereof, as the photographic bleaching agent(s),
from about 0.1 to about 2 mol/l of a thiosulfate as the sole photographic fixing agent,
from about 0.01 to about 10 mmol/l of 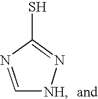
from about 0.01 to about 2 mol/l of sulfite ions that are sufficient to convert at least 75 mol % of said ferric ion to ferrous ion within 30 days at 20 to 45° C.,
wherein at least 95 mol % of the total ammonium and alkali metal cations in said bleach-fixing composition are ammonium ions, and said bleach-fixing composition is substantially free of phosphates, polyphosphates, polyphosphonates, nitrates, and bromide ions,
said contacting being carried out for less than 60 seconds.

20. The method of claim 19 wherein said color development is carried out for less than 50 seconds, and said bleach-fixing contacting is carried out for less than 50 seconds.

21. A method of providing a stabilized single-part bleach-fixing composition that has a pH of from about 4.4 to about 5.4 and at least 50 mol % ferrous ammonium-ligand compound, based on total iron concentration, said method comprising mixing at least the following components (a), (b), and (c):
(a) at least 0.1 mol/l of an iron ammonium-ligand photographic bleaching agent that comprises at least 95 mol % a ferric ammonium-ligand photographic bleaching agent, based on total iron, provided that the ligand in said bleaching agent is not diethylenetriaminepentaacetic acid,
(b) at least 0.1 mol/l of a thiosulfate as the sole photographic fixing agent, and
(c) sulfite ions in an amount sufficient to convert at least 50 mol % of said ferric ammonium-ligand photographic bleaching agent to ferrous ammonium-ligand compound within 30 days at 20 to 45° C.,
provided that at least 90 mol % of the total ammonium and alkali metal cations mixed into said bleach-fixing composition are ammonium ions, and substantially no phosphates, polyphosphates, polyphosphonates, nitrates, or bromide ions are mixed into said bleach-fixing composition.

22. A method of converting ferric ions to ferrous ions in a composition comprising:
A) mixing at least the following components (a), (b), and (c):
(a) at least 0.1 mol/l of an iron ammonium-ligand photographic bleaching agent that comprises at least 95 mol % a ferric ammonium-ligand photographic bleaching agent, based on total iron, provided that the ligand in said bleaching agent is not diethylenetriaminepentaacetic acid,
(b) at least 0.1 mol/l of a thiosulfate as the sole photographic fixing agent, and
(c) sulfite ions,
B) holding said mixture of (a), (b), and (c) for up to 30 days at 20 to 45° C.,
provided that at least 90 mol % of the total ammonium and alkali metal cations mixed into said bleach-fixing composition are ammonium ions, and substantially no phosphates, polyphosphates, polyphosphonates, nitrates, or bromide ions are mixed into said bleach-fixing composition, and
further provided that said sulfite ions are present in an amount sufficient to convert at least 50 mol % of said ferric ammonium-ligand photographic bleaching agent to ferrous ammonium-ligand compound under the conditions of step B.

23. The method of claim 22 wherein said mixture of (a), (b), and (c) is held in a capped high density polyethylene container.
